(19) United States
(12) Patent Application Publication
(10) Pub. No.: US 2005/0094498 A1
(43) Pub. Date: May 5, 2005

(54) Portable watch

(76) Inventors: Hideaki Koshoji, Chiba-shi (JP); Koremoto Takeda, Chiba-shi (JP)

Correspondence Address: ADAMS & WILKS;31st Floor, 50 Broadway, New York, NY, 10004, US

(21) Appl. No.: 10/965,179

(22) Filed: Oct. 14, 2004

(30) Foreign Application Priority Data
Oct. 23, 2003 (JP) 2003-362729

(51) Int. Cl. G04B 29/00

(52) U.S. Cl. 368/319

(57) ABSTRACT

To provide a portable watch in which a crown can be held so as not to be turned carelessly utilizing engagement of screws without being restricted by a function of a watch movement, durability is improved, and a screw lock operation for the crown is light. The present invention is premised on a portable watch in which a crown, which is connected to a winding stem transmitting a turning force to a watch movement in a case band, is engaged with a male screw section of a pipe attached to the case band, whereby a crown is held so as not to be turned. The crown includes: a crown shaft that moves the winding stem in association with the crown shaft; and a crown head that turns this shaft. A turning force receiving section is provided on a peripheral part of a shaft end of a crown shaft arranged outside the pipe. A female screw section and a turning force transmission section are provided in the crown head. The female screw section is detachably engaged with the male screw section. The turning force transmission force is detachably fitted into the turning force receiving section following movement along an axial direction of the crown shaft in a state in which the engagement of both the screw sections are released.

### BACKGROUND OF THE INVENTION

1. Field of the Invention

The present invention relates to a portable watch in which a crown is held so as not to be turned carelessly utilizing engagement of screws.

2. Description of the Prior Art

Conventionally, a crown for operating a watch movement incorporated in a case band is a single component and includes a crown shaft section that moves the watch movement in association with the crown shaft section and a crown head that is formed integrally with this shaft section. The crown shaft section is inserted in a winding stem pipe, which is attached to the case band, and the crown head is fitted into a pipe end, which is located outside the case band, of the winding stem pipe.

There is known a portable watch in which, in order to prevent this crown from being turned carelessly, a male screw section is formed on an outer periphery of the pipe end, which is located outside the case band, of the winding stem pipe, and a female screw section is formed in the crown head to detachably engage the male screw section at the pipe end (see JP-A-57-46181 (page 1, right column, line 8 to page 2, left column, line 7, and FIGS. 1 and 2)).

In this portable watch, in a normal state in which the watch movement is not operated, the crown is engaged with the male screw section of the pipe to bring the crown head into abutment against an outside surface of the case band, whereby careless turn of the crown can be controlled. An operation for holding the crown such that the crown is not turned carelessly will be hereinafter referred to as a screw lock operation, and a state in which the crown is held will be hereinafter referred to as a screw lock state. In addition, when the watch movement is operated, the winding stem connected to the watch movement can be turned together with the crown after the engagement of the crown with the male screw section is released to bring the crown into a pulled state.

Incidentally, a mechanical portable watch, in which a watch movement operated by a winding stem has a spiral spring as a drive source, is made such that, in a state in which a crown is arranged in a position where the crown is not pulled out, the spiral spring is wound up by a turning operation for this crown. In addition, a portable watch, in which a watch movement operated by a winding stem has plural operation modes, is made such that, in a state in which a crown is arranged in a position where the crown is not pulled out, the operation modes are switched by a turning operation for this crown.

Note that the state, in which a crown is arranged in a position where the crown is not pulled out, is generally referred to as a “zero stage”. On the other hand, a position where the crown is pulled out for calendar adjustment or the like is generally referred to as a “first stage”. There is also known a portable watch in which, depending upon a situation, a crown can be pulled out to a pulled-out position of a “second stage”that is a position for time setting.

It is unpreferable to apply the technique of the JP-A-57-46181 to a portable watch, which has a function of winding up a spiral spring with a crown arranged in a “zero stage”, or a portable watch, which has a function of changing an operation mode, due to the following reasons.

That is, in the portable watch of the JP-A-57-46181, the crown shaft section and the crown head are integrally formed. Thus, in the screw lock operation for engaging the crown in the male screw section of the winding stem pipe, since the crown shaft section is also turned, the winding stem connected to this crown shaft section is also turned together with the crown.

Consequently, in the application of the present invention to the portable watch having the function of winding up the spiral spring, the spiral spring is wound up as the crown is engaged with the male screw section of the winding stem pipe. A winding-up operation for the spiral spring is performed by manual winding or automatic winding. However, it is impossible to know in which winding state the spiral spring in the case band is. Therefore, in a state in which the spiral spring is wound up to a considerable degree, the screw lock operation with respect to the crown may be performed. In this case, the screw lock operation becomes particularly heavy, which is inconvenient. Accordingly, an excessive operation force is applied to the male screw section and the female screw section, and abrasion of these screw sections is accelerated.

Further, in the application of the present invention to the portable watch having the function of changing an operation mode, an operation mode is changed freely following the screw lock operation with respect to the crown. Consequently, the technique, which utilizes engagement of screws to prevent a crown from being turned carelessly, cannot be applied to the portable watch of this type.

A problem that the present invention is to solve is in providing a portable watch in which a crown can be held so as not to be turned carelessly utilizing engagement of screws without being restricted by a function of a watch movement, durability can be improved, and a screw lock operation for the crown is light.

### SUMMARY OF THE INVENTION

In order to solve the problem, the present invention is a portable watch in which a crown is held so as not to be turned carelessly utilizing engagement of screws, the crown including: a crown shaft that has a turning force receiving section in a peripheral part of a shaft end arranged outside a pipe and moves a winding stem in association with the crown shaft; and a crown head that has a female screw section, which is detachably engaged with a male screw section, and a turning force transmission section, which is detachably joined to the turning force receiving section following movement along an axial direction of the crown shaft in a state in which this engagement is released.

In the present invention, by releasing the engagement of the female screw section of the crown head with the male screw section of the pipe, restraint of the crown head is released to allow this crown head to turn, and a relative position of the crown head and the crown shaft with respect to the axial direction changes, and the turning force transmission section of the crown head is joined to the turning force receiving section of the crown shaft. Consequently, a turning operation for the crown head under this state is transmitted to the crown shaft via the turning force transmission section and the turning force receiving section. Consequently, as the winding stem is turned, the watch movement in the case band can be operated. After this operation, the crown head is moved in the axial direction so as to come closer to an outside surface of the case band, and the female screw section of the crown head is engaged with the male screw section of the pipe, whereby, first, the turning force transmission section is detached from the turning force receiving section, and then the crown head comes into abutment against the outside surface of the case band to come into the screw lock state. In this case, after the turning force transmission section is detached from the turning force receiving section, since the crown shaft and the crown head are not joined, the crown head is capable of turning freely. Thus, it is possible to prevent the crown shaft from turning following the screw lock operation for obtaining the screw lock state, which has been already described, to transmit the turn to the watch movement.

In a preferred form of the present invention, since the turning force transmission section and the turning force receiving section are formed in a polygon or a gear shape, the turning force transmission section and the turning force receiving section fit to each other to be coupled. Consequently, the present invention is excellent in that a turning operation for the crown head can be transmitted to the crown shaft surely via the turning force transmission section and the turning force receiving section without causing slippage between the turning force transmission section and the turning force receiving section.

In a preferred form of the present invention, the shaft end has a stopper section, and an abutment section, which comes into contact with the stopper section from the case band side and separates from the stopper section following attachment and detachment of the turning force transmission section to and from the turning force receiving section, is provided in the crown head. Thus, after detaching the crown head from the male screw section of the pipe, the abutment section can be brought into abutment against the stopper section. Consequently, the present invention is excellent in that the crown head can be prevented from coming off without requiring a specific component.

In a preferred form of the present invention, the crown head includes: a cylindrical head body that has the female screw section and the turning force transmission section and houses the shaft end; and a cap that is attached to this head body and covers the shaft end. Thus, the present invention is excellent in that visual recognition of the crown shaft can be prevented by the cap to realize a preferable appearance.

In a preferred form of the present invention, an elastic body, which biases the crown head in a direction in which the crown head moves away from an outside surface of the case band, is provided between the cap and the crown shaft. Thus, the present invention is excellent in that, simultaneously with the engagement of the male screw section and the female screw section being released, the crown head can be moved in an axial direction thereof by a biasing force of the elastic body such that the abutment section is hooked on to the stopper section.

### BRIEF DESCRIPTION OF THE SEVERAL VIEWS OF THE DRAWINGS

A preferred form of the present invention is illustrated in the accompanying drawings in which:

FIG. 1 is a front view showing a wristwatch in accordance with a first embodiment of the present invention;

FIG. 2 is a sectional view showing a screw lock state of a crown along a line Z-Z in FIG. 1;

FIG. 3 is a sectional view showing a state, in which the screw lock state of the crown is released, along the line Z-Z in FIG. 1;

FIG. 4 is a sectional view of the crown along a line Y-Y in FIG. 3; and

FIG. 5 is a sectional view equivalent to FIG. 4 showing a crown included in a wristwatch in accordance with a second embodiment of the present invention.

### DETAILED DESCRIPTION OF THE PREFERRED EMBODIMENTS

(First Embodiment)

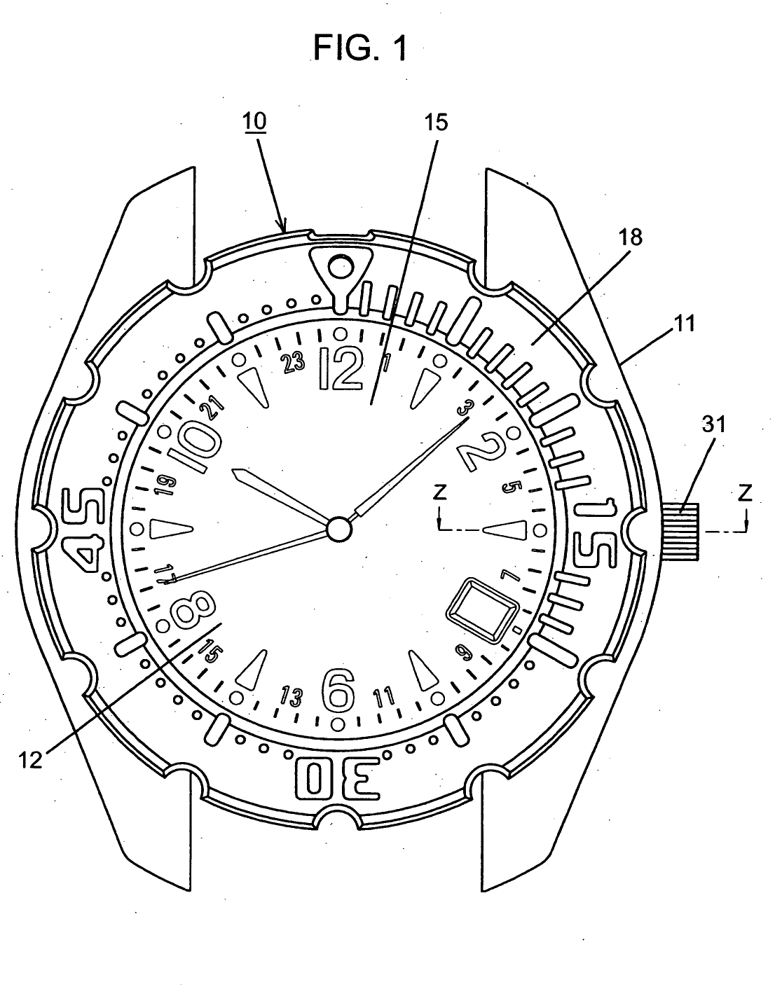

A first embodiment of the present invention will be explained with reference to FIGS. 1 to 4.

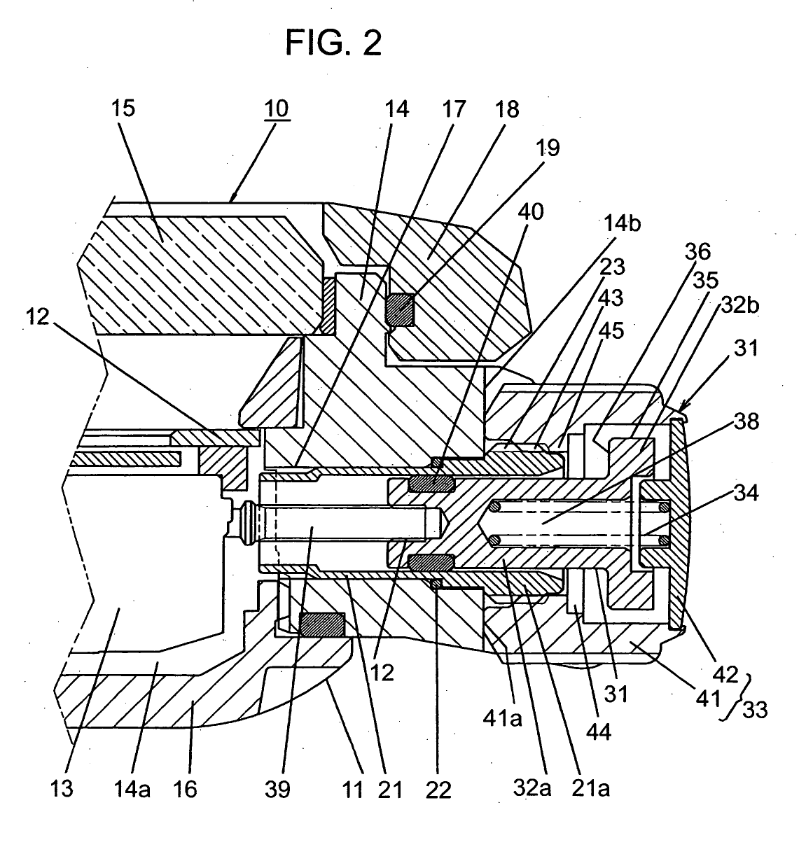

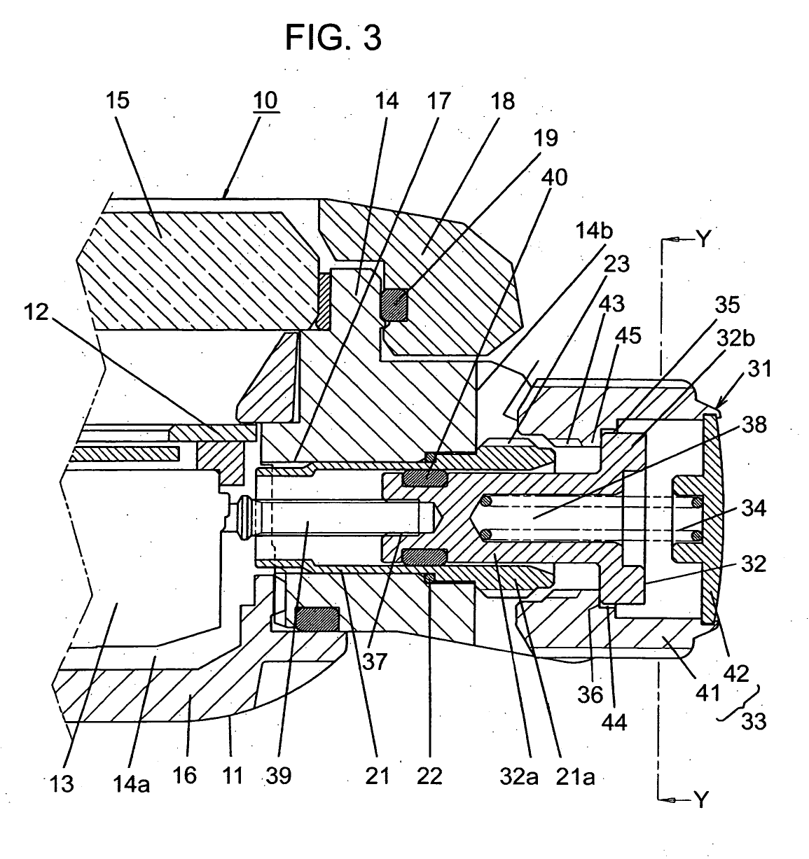

In FIG. 1, reference numeral 10 denotes a wristwatch as a portable watch. As shown in FIGS. 2 and 3, this wristwatch 10 houses a dial 12, a not-shown watch movement 13, and the like in a watch exterior assembly 11. As the watch movement 13, a mechanical watch movement of a manual winding type with a spring as a drive source, an automatic winding type, or a type using both manual winding and automatic winding is used. Note that, instead of these types, a watch movement of a type, which can select and switch digital display and analog display as time display or the like on the dial 12, may be adopted.

As shown in FIGS. 2 and 3, the watch exterior assembly 11 is formed by mounting a cover glass 15 liquid-tightly on a front surface, which consists of one surface in a thickness direction, of an annular metal case band 14, and screwing a case back 16 consisting of metal or the like liquid-tightly onto a rear surface, which consists of the other surface in the thickness direction, of the case band 14. The dial 12 is visually recognizable through the cover glass 15. The case back 16 is removable. Note that, in FIGS. 1 to 3, reference numeral 18 denotes an annular bezel that is attached to the watch exterior assembly 11 so as to be capable of turning. This bezel 18 is adapted to be held in an arbitrary turning position by a friction force of an annular elastic ring 19 shown in FIGS. 2 and 3. The bezel 18 may not be provided.

As shown in FIGS. 2 and 3, a pipe attachment hole 17, which pierces this case band 14 in a radial direction, is opened in a part of the case band 14. One end of the pipe attachment hole 17 is opened in a space in case band 14a surrounded by the case band 14, and the other end of the pipe attachment hole 17 is opened on an outside surface 14b of the case band 14.

A pipe (which may also be referred to as a winding stem pipe) 21 is inserted into the pipe attachment hole 17 from the outside of the case band and attached to the case band 14 by brazing or the like. In FIGS. 2 and 3, reference numeral 22 denotes a brazing material. The pipe 21 made of metal, for example, stainless steel is formed in a cylindrical shape and opened at both ends in an axial direction thereof, respectively, includes a pipe end 21a arranged outside the case band 14, and has a male screw section 23 for holding a crown 31 in the screw lock state on an outer periphery of this pipe end 21a.

The crown 31 includes a crown shaft 32, a crown head 33, and an elastic body, for example, a coil spring 34.

The crown shaft 32 is made of, for example, metal, preferably stainless steel. As shown in FIGS. 2 and 3, the crown shaft 32 includes: a columnar inserting shaft section 32a that is inserted into the pipe 21 from the outside of the case band 14; and a shaft end 32b that continues integrally with this inserting shaft section 32a and is arranged in the outside of the pipe 21. The shaft end 32b has a diameter equal to or larger than an outer diameter of the male screw section 23.

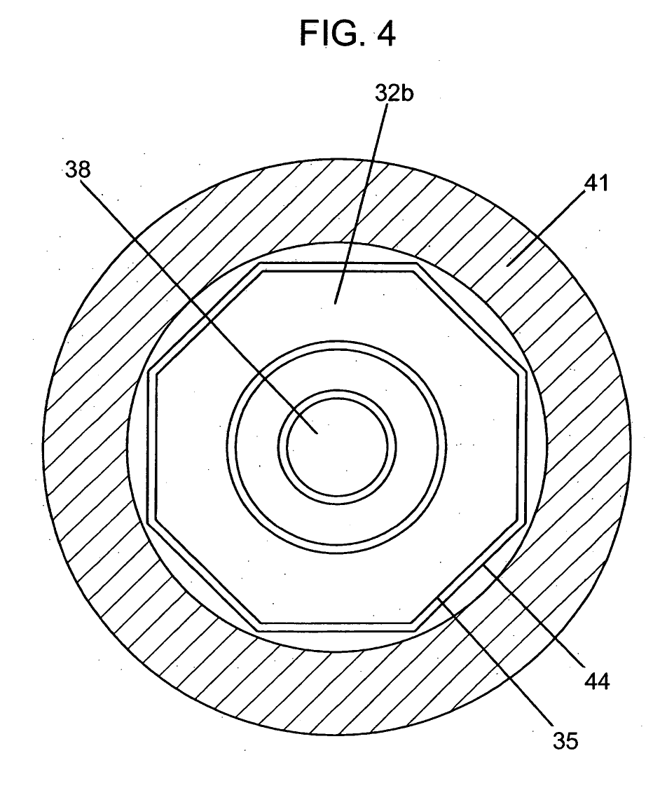

A peripheral part of this shaft end 32b forms a turning force receiving section 35. For example, as shown in FIG. 4, this turning force receiving section 35 is made in a regular polygon, more specifically, a regular octagon. Moreover, a side of the shaft end 32b closer to the case band 14 is a side projecting from the inserting shaft section 32a at a right angle. This side is used as a stopper section 36.

In the crown shaft 32, a screw hole 37, which is cut in along in the axial direction from a tip side of the inserting shaft section 32a, is provided, and a spring housing hole 38, which is opened in a central part of an end face of the shaft end 32b, is also provided.

A winding stem 39, which transmits a turning force of the crown 31 to the watch movement 13, is screwed into the screw hole 37 of the inserting shaft section 32a from the inside of the case band. The winding stem 39 and the crown shaft 32, which are coupled with each other in this way, cannot move in the axial direction. An annular waterproof gasket 40 made of an elastic material such as rubber is inserted in an annular recess formed on an outer periphery of the tip of the inserting shaft section 32a. This waterproof gasket 40 elastically adheres to the annular recess and an inner periphery of the pipe 21. Consequently, a part between the inner periphery of the pipe 21 and the crown shaft 32 is waterproofed.

As shown in FIGS. 2 and 3, the crown head 33 is formed to have a cylindrical head body 41 of a size enough for housing the male screw section 23 and the shaft end 32b, and a cap 42 attached to this head body 41.

The head body 4l is made of, for example, metal, preferably, stainless steel and has a groove (not shown in FIG. 4) for preventing slippage in a turning operation on an outer periphery thereof. An opened one end face 41a of this head body 41 is formed as a surface that comes into contact with and separates from the outside surface 14b of the case band 14. A female screw section 43, which is removably engaged with the female screw section 23 in order to obtain the screw lock state of the crown 31, is formed on an inner periphery closer to the one end face 41a of the head body 41.

A turning force transmission section 44 adjacent to the female screw section 43 is provided on an inner periphery of the head body 41. This turning force transmission section 44 is a section that is attached to and detached from the turning force receiving section 35 following movement in the axial direction of the crown head 33. The turning force transmission section 44 is formed of a fitting hole that has a shape similar to the turning force receiving section 35, that is, in the case of this embodiment, a regular octagon as illustrated in FIG. 4.

A part between the turning force transmission section 44 and the female screw section 43 is used as an abutment section 45 formed in an annular shape. This abutment section 45 is a section that comes into contact with and separates from the stopper section 36 following movement in the axial direction of the crown head 33. The abutment section 45 is also used as a section that regulates a fitting depth of the turning force transmission section 44 into the turning force receiving section 35.

Note that it is desirable to make the head body 41, which has the above structure, of a metal casting. In the case of a casting, the turning force transmission section 44 can be formed simultaneously with casting. Consequently, labor and time for machining this turning force transmission section 44 are never required. Therefore, the head body 41 can be obtained at low cost.

The cap 42 is made of a material of the same type as the head body 41 or hard synthetic resin. This cap 42 is attached to cover an end opening of the head body 41 by caulking the head body 41 in a state in which a peripheral part thereof is fitted into a groove provided on an inner periphery at the other end of the head body 41. This is preferable in that the shaft end 32b of the crown shaft 32 can be covered by the cap 42 so as not to be visually recognized, and an appearance around the crown can be improved.

Moreover, in the structure in which the crown head 33 is formed of the head body 41 and the cap 42, the cylindrical head body 41 is in a state in which both ends in an axial direction thereof are opened at a stage before the cap 42 is attached to the head body 41. This is also preferable in that the cap 42 does not prevent machining of the female screw section 43 or the like with respect to an inner peripheral surface of the head body 41.

The coil spring 34 is housed in the spring housing hole 38 of the crown shaft 32 and is nipped between a central part of the cap 42 opposed to this housing hole 38 and the crown shaft 32. This coil spring 34 always biases the crown head 33 in a direction in which the crown head 33 moves away from the outside surface 14b of the case band 14.

In the wristwatch 10 including the above-mentioned structure, a state in which the crown 31 is arranged in a position where the crown 31 is not pulled out (generally referred to as a “zero stage”) is shown in FIG. 2. In this “zero stage”, the female screw section 43 of the head body 41 of the crown head 33 is engaged with the male screw section 23 of the pipe 21, and the one end face 41a of the head body 41 is positioned in contact with the outside surface 14b of the case band 14. At the same time, the turning force transmission section 44 of the crown head 33 is placed close to the pipe end 21a and deviates to the case band 14 side with respect to the shaft end 32b of the crown shaft 32, more specifically, the turning force receiving section 35 of this shaft end 32b. That is, the crown head 33 and the crown shaft 32 are held in a state in which the crown head 33 and the crown shaft 32 have no joining relation.

Consequently, in a state in which the coil spring 34 is compressed strongly between the cap 42 of the crown head 33 and the crown shaft 32, regardless of the fact that the crown head 33 is biased in the direction in which the crown head 33 moves away from the case band 14, the crown head 33 is not moved in the axial direction because of the engagement. In this way, the crown 31 is in the screw lock state in the “zero stage”.

When time setting for the watch movement 13 is performed, the crown head 33 in the screw lock state is pulled out to the position, which generally referred to as the “first stage”, and turned. That is, first, the crown head 33 is turned in a loosening direction to bring the crown head 33 into a state in which the female screw section 43 thereof is disengaged from the male screw section 23 of the pipe 21. In this case, again, since the crown head 33 and the crown shaft 32 do not have a joining relation, the crown shaft 32 is never turned in association with the crown head 33 following a free turning operation for the crown head 33 for releasing engagement.

Simultaneously with the engagement of the screws being released, the crown head 33 is moved easily without a manual operation along the axial direction of the crown shaft 32 so as to be further apart from the outside surface 14b of the case band 14 by a spring force (biasing force) of the coil spring 34.

In accordance with the movement in the axial direction of the crown head 33, the crown shaft 32 and the crown head 33 are coupled. That is, the turning force transmission section 44 of the crown head 33 is fitted to an outer periphery of the turning force receiving section 35 of the crown shaft 32, and the crown shaft 32 and the crown head 33 are joined so as to transmit the turn in the axial direction. Therefore, the turning force receiving section 35 and the turning force transmission section 44 function as an engagement clutch that couples the crown shaft 32 and the crown head 33 so as to make it possible to turn the crown shaft 32 following the crown head 33 in a state in which the engagement is released.

At the same time, the abutment section 45 of the crown head 33 comes into abutment against the stopper section 36 of the crown shaft 32, a fitting depth of the turning force transmission section 44 into the turning force receiving section 35 along the axial direction is regulated, and the movement in the axial direction of the crown head 33 is regulated to prevent the crown head 33 from coming off. The crown head 31 released from the screw lock state is held in the pulled-out position, which is generally referred to as the “first stage”, by positioning according to this regulation as shown in FIG. 3. Note that, in such coupling of the crown shaft 32 and the crown head 33, labor and time for slightly turning the crown head 33 may be required.

By manually turning the crown head 33 of the crown 31 in the pulled-out position of the crown head 33 explained above, this turn of the crown head 33 is transmitted to the crown shaft 32 via the turning force transmission section 44 and the turning force receiving section 35. Since a turning force is given to the watch movement 13 via the winding stem 39 following the transmission of the turn, adjustment such as time setting for this watch movement 13 can be performed.

After this adjustment, the crown 31 is brought into the lock state (see FIG. 2) again. An operation for obtaining this screw lock state is carried out by pushing back the crown head 33 in the direction of the case band 14 against the coil sprig 34, and then turning the female screw section 43 of this crown head 33 in a tightening direction to screw the female screw section 43 into the male screw section 23 of the pipe 21. Consequently, since the one-end face 41a of the crown head 33 comes into abutment against the outside surface 14b of the case band 14, the crown 31 can be brought into the screw lock state so as not to be turned carelessly at the time when the wristwatch 10 is carried or the like.

In this operation for obtaining the screw lock state, in the beginning, the turning force transmission section 44 is released from the turning force receiving section 35 as the crown head 33 is pushed back in the direction of the case band 14. Thus, the coupling of the crown head 33 and the crown shaft 32 is released. Thereafter, the crown head 33 is turned to engage the female screw section 43 with the male screw section 23.

In a state in which the crown head 33 and the crown shaft 32 are not coupled in this way, since the crown head 33 is turned in the tightening direction, this turn in the tightening direction of the crown head 33 is never transmitted to the crown shaft 32.

As described above, the crown shaft 32 never turns following the screw lock operation, which has already been described, for obtaining the screw lock state to transmit the turn to the mechanical watch movement 13. Thus, in the screw lock operation, the spiral spring included in the watch movement 13 is prevented from becoming a load. Therefore, for example, even in a state in which the spiral spring is wound up considerably, the screw lock operation for the crown 31 can be performed lightly, and operability is high.

Note that, in the case in which the watch movement 13 is not mechanical but has the function of changing an operation mode with the crown 31 arranged in the “zero stage” position, a turning force is controlled not to spread to the watch movement following the screw lock operation for the crown 31 as described above. Thus, an operation mode is never changed carelessly.

In addition, since the screw lock operation in the mechanical clock movement 13 having the spiral spring can be performed lightly as described already, an excessive turning operation force is never applied to the male screw section 23 and the female screw section 43. Thus, durability of these screw sections 23 and 43 can be improved.

Moreover, as described already, regardless of the movement in the axial direction of the crown head 33 at the time of the screw lock operation and at the time when the screw lock state is released, the crown shaft 32 is never moved in the axial direction. A device for,preventing the movement in the axial direction of the crown shaft 32 from spreading to the winding stem 39 is not required in the winding stem 39 and the crown shaft 32, and the winding stem 39 and the crown shaft 32 can be connected by a simple screw-in structure.

Consequently, in particular, machining cost for the winding stem 39 can be reduced, which contributes to cost reduction for the entire wristwatch. Note that, if a conventional structure is explained for comparison, the conventional structure adopts a structure in which a winding stem is subjected to cutting for providing a width of across flat, a washer with a fitting hole having a width of across flat is fitted to this winding stem, and this washer is fixed to a crown shaft, whereby movement in an axial direction of the crown shaft with respect to the winding stem is allowed, and on the other hand, the winding stem is turned together with the turn of the crown.

Moreover, since a screw shaft can be adopted for the winding stem 39, in assembling the wristwatch 10, the winding stem 39 does not have to be fixed to the crown 31 in advance to prepare a crown with a winding stem, and it is possible to retrofit the winding stem 39 to the crown shaft 32. Consequently, the winding stem 39 with a screw section machined to have a maximum length in advance can be cut in a necessary length so as to comply with a size of the watch exterior assembly 11 that is different depending upon a type of the wristwatch 10, a dimension or the like necessary for obtaining the screw lock state, and the like, and screwed in the crown shaft 32 and connected. Therefore, in manufacturing, versatility of the winding stem 39 increases to make the winding stem 39 usable commonly in many kinds of wristwatches 10. This contributes to reduction in cost for the entire wristwatch 10.

(Second Embodiment)

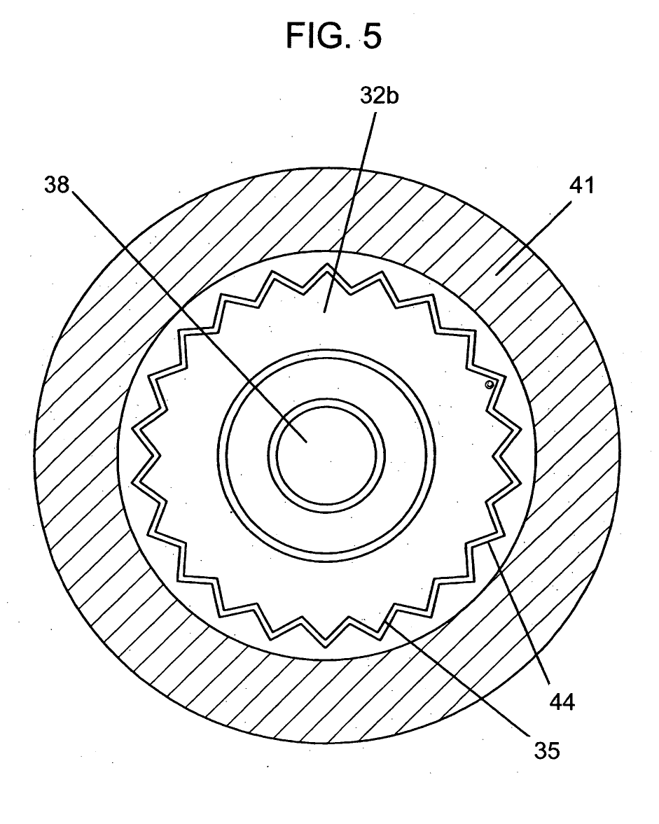

A second embodiment of the present invention will be explained with reference to FIG. 5. Since this second embodiment is basically the same as the first embodiment, components same as those in the first embodiment are denoted by reference numerals and signs identical with those in the first embodiment, and an explanation about the components will be omitted. Components different from those in the first embodiment will be explained.

In the second embodiment, the turning force receiving section 35 formed in an external gear shape is provided on the peripheral part of the shaft end 32b of the crown shaft 32, and the turning force transmission section 44 of an internal gear shape, which detachably fits into the turning force receiving section 35, is provided on an inner periphery of the head body 4l of the crown head 33. Other than the points explained here, the second embodiment including the structures not shown in FIGS. 4 and 5 is the same as the first embodiment.

Therefore, even with the wristwatch 10 of this second embodiment, the same action as the first embodiment can be obtained to solve the problems that the present invention is to solve. Moreover, since the turning force transmission section 44 and the turning force receiving section 35 are formed in a gear shape, in fitting the turning force transmission section 44 and the turning force receiving section 35, if it is necessary to turn the crown head 33, an amount of the turn only has to be at least one pitch of a gear. Thus, the wristwatch 10 is excellent in that operation is easy.

The present invention is not limited to both the embodiments described above. For example, the coil spring 34 of the crown 31 may not be provided. In this case, when the crown head 33 is brought into the screw lock state, the crown head 33 does not have to be subjected to resistance of the coil spring 34. Consequently, the crown head 33 can be moved in the axial direction with a light operation toward the outside surface 14b of the case band 14.

According to the present invention, it is possible to control the crown shaft not to turn following the screw lock operation to transmit the turn to the watch movement. Consequently, a portable watch can be provided in which the screw lock operation for the crown can be performed lightly and durability of the male screw section of the pipe and the female screw section of the crown head can be improved, and moreover, it is possible to hold the crown so as not to be turned carelessly utilizing engagement of screws without being restricted by functions of the watch movement, for example, a function of winding up a spiral spring and a function of changing an operation mode.

1. A portable watch comprising:
a pipe having a male screw section which is located outside a case band incorporating a watch movement and is attached to the case band;
a crown which is connected to a winding stem transmitting a turning force to the watch movement and is detachably engaged with an outer periphery of the male screw section
wherein the crown is held by this engagement so as not to be turned carelessly,and
the crown includes a crown shaft that has a turning force receiving section in a peripheral part of a shaft end arranged outside a pipe and moves a winding stem in association with the crown shaft, and a crown head that has a female screw section which is detachably engaged with a male screw section, and a turning force transmission section, which is detachably joined to the turning force receiving section following movement along an axial direction of the crown shaft in a state in which this engagement is released.

2. A portable watch according to claim 1, wherein the turning force transmission section and the turning force receiving section are formed in a polygon or a gear shape.

3. A portable watch according to claim 1, wherein the shaft end has a stopper section, and an abutment section, which comes into contact with the stopper section from the case band side and separates from the stopper section following attachment and detachment of the turning force transmission section to and from the turning force receiving section, is provided in the crown head.

4. A portable watch according to claim 3, wherein the crown head includes a cylindrical head body that has the female screw section and the turning force transmission section and houses the shaft end, and a cap that is attached to this head body and covers the shaft end.

5. A portable watch according to claim 4, wherein an elastic body, which biases the crown head in a direction in which the crown head moves away from an outside surface of the case band, is provided between the cap and the crown shaft.
